(19) United States
(12) Patent Application Publication
(10) Pub. No.: US 2014/0220313 A1
(43) Pub. Date: Aug. 7, 2014

(54) LIGHT BLOCKING SHEET, METHOD FOR MANUFACTURING LIGHT BLOCKING SHEET, AND TRANSPARENT DISPLAY DEVICE

(71) Applicant: Samsung Display Co., Ltd., Yongin-City (KR)

(72) Inventors: Yun-Ho KIM, Yongin-City (KR); Jeong-Seok OH, Yongin-City (KR); Kang-Yong LEE, Yongin-City (KR)

(73) Assignee: Samsung Display Co., Ltd., Yongin-City (KR)

(21) Appl. No.: 14/170,233

(22) Filed: Jan. 31, 2014

(30) Foreign Application Priority Data
Feb. 1, 2013 (KR) 10-2013-0011965

(51) Int. Cl. G02B 5/00; B29C 69/00

(52) U.S. Cl. CPC G02B 5/00; B29C 69/001
USPC 428/195.1; 264/154

(57) ABSTRACT

A light blocking sheet includes: a plurality of light transmission portions extending in a first direction and arranged at a distance from each other along a second direction that crosses the first direction; and a plurality of light blocking portions extending in the first direction, each of the plurality of light blocking portions being disposed between two immediately neighboring light transmission portions.

### RELATED APPLICATIONS

This application claims priority to and the benefit of Korean Patent Application No. 10-2013-0011965 filed in the Korean Intellectual Property Office on Feb. 1, 2013, the entire contents of which are incorporated herein by reference.

### BACKGROUND

1. Field

The described technology relates generally to a light blocking sheet, a method for manufacturing a light blocking sheet, and a transparent display device.

2. Description of the Related Art

A display device is a device that displays an image, and currently, an organic light emitting diode (OLED) display is receiving attention.

Since the organic light emitting diode (OLED) display has a self-light emitting characteristic such that a separate light source is not required, unlike a liquid crystal display (LCD), thickness and weight thereof may be reduced.

In general, the OLED display includes a substrate, an organic light emitting diode disposed on the substrate, and an encapsulation portion sealing the organic light emitting diode together with the substrate.

Recently, the OLED display has been realized as a transparent display device by including a light transmission area that neighbors the organic light emitting diode.

However, the transparent display device causes reflection of external light that is made incident to the transparent display device so that visibility of an image displayed in the transparent display device is deteriorated.

The above information disclosed in this Background section is only for enhancement of understanding of the background of the described technology and therefore it may contain information that does not form the prior art that is already known in this country to a person of ordinary skill in the art.

### SUMMARY

The described technology has been made in an effort to provide a light blocking sheet that can improve visibility of an image displayed in a transparent display device by suppressing external light reflection of the transparent display device, a method for manufacturing the light blocking sheet, and the transparent display device.

One aspect of the present invention provides a light blocking sheet that includes: a plurality of light transmission portions extending in a first direction and arranged at a distance from each other along a second direction that crosses the first direction; and a plurality of light blocking portions extending in the first direction, each of the plurality of light blocking portions being disposed between two immediately neighboring light transmission portions.

A crossing angle of the first direction and the second direction may be about 90°.

The light transmission portions and the light blocking portions may respectively extend in a third direction that intersects the first direction and the second direction.

A crossing angle between the first direction and a direction that may be perpendicular to the second direction is greater than 0°.

A second aspect of the present invention provides a method for manufacturing a light blocking sheet. The method includes: forming a plurality of concave slits extending in a first direction in a transparent base substrate and arranged at a distance from each other along a second direction that crosses the first direction, and a plurality of light transmission portions extending in the first direction, each of the plurality of light transmission portions being disposed between two immediately neighboring slits; forming a plurality of light blocking portions by filling the plurality of slits with a light blocking material such that the plurality of light blocking portions extend in the first direction, and each of the plurality of light blocking portions is disposed between two immediately neighboring light transmission portions; and cutting the transparent base substrate to separate the light transmission portions and the light blocking portions from the transparent base substrate.

In addition, a third aspect of the present invention provides a transparent display device including a transparent display panel displaying an image, and the light blocking sheet of any one of claim 1 to claim 4 attached to a bottom surface of the transparent display panel.

The second direction may be substantially parallel to the bottom surface of the transparent display panel.

According to one of the exemplary embodiments, a light blocking sheet that can selectively block external light and improve visibility of an image displayed in a transparent display device by suppressing external light reflection of a transparent display panel, a method for manufacturing a light blocking sheet, and a transparent display device can be provided.

### BRIEF DESCRIPTION OF THE DRAWINGS

FIG. 1 is provided for description of a method for manufacturing a light blocking sheet according to a first exemplary embodiment.

FIG. 2 illustrates a light blocking sheet according to a second exemplary embodiment.

FIG. 3 shows a transparent display device according to a third exemplary embodiment.

FIG. 4 is provided for description of an effect of the transparent display device according to the third exemplary embodiment.

FIG. 5 illustrates a transparent display device according to a fourth exemplary embodiment.

FIG. 6 shows the portion “A” of FIG. 5.

### DETAILED DESCRIPTION

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

In the drawings, the size and thickness of each element are approximately shown for better understanding and ease of description. Therefore, the present invention is not limited to the drawings.

In the drawings, the thickness of layers, films, panels, regions, etc., are exaggerated for clarity. Further, in the drawings, the thicknesses of layers and regions are exaggerated for better understanding and ease of description.

In addition, unless explicitly described to the contrary, the word “comprise” and variations such as “comprises” or “comprising” will be understood to imply the inclusion of stated elements but not the exclusion of any other elements.

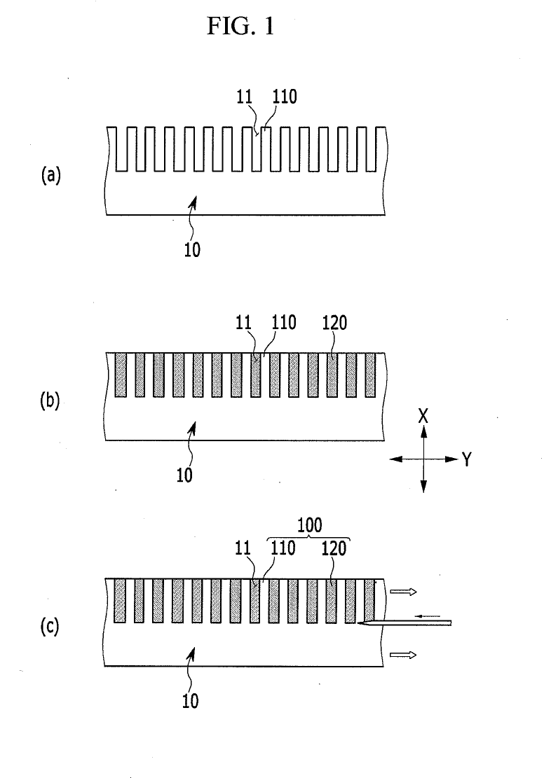

Hereinafter, a method for manufacturing a light blocking sheet according to a first exemplary embodiment will be described with reference to FIG. 1.

FIG. 1 is provided for description of a method for manufacturing a light blocking sheet according to the first exemplary embodiment.

First, as shown in (a) of FIG. 1, a plurality of slits 11 and a plurality of light transmission portions 110 are formed in a transparent base substrate 10 which includes a major surface.

In further detail, the transparent base substrate 10 is formed of an organic material, an inorganic material, or a metal, and the plurality of slits 11 are recessed along a first direction X which is non-parallel to the major surface and to form the plurality of slits arranged at a distance from each other along a second direction Y which is substantially parallel to the major surface and crosses the first direction X. Each of the slits 11 is recessed with a predetermined depth in the first direction X.

For example, the plurality of slits 11 may be formed by using a molding roll including protrusions having a shape that corresponds to the shape of the slits 11, or may be formed by using a stamp including protrusions having a shape that corresponds to the shape of the slits 11.

The plurality of slits 11 are formed in the transparent base substrate 10 so that the light transmission portions 110 are respectively formed between neighboring slits 11. Thus, in embodiments, each of the light transmission portions 110 is disposed between two immediately neighboring slits 11. The plurality of light transmission portions 110 extend in the first direction X and respectively disposed between neighboring slits 11 along the second direction Y.

When the transparent base substrate 10 is made of an organic material, the transparent base substrate 10 may include at least one of polyethylene terephthalate, polyimide, polycarbonate, polyethylene, and polyacrylate. In addition, when the transparent base substrate 10 is made of an inorganic material, the transparent base substrate 10 may include at least one of glass, silicon oxide, silicon nitride, indium tin oxide, and indium zinc oxide.

Next, as shown in (b) of FIG. 1, a plurality of light blocking portions 120 are formed by filling the plurality of slits 11 with a light blocking material.

In further detail, the plurality of light blocking portions 120 are formed to extend in the first direction X and to be respectively disposed between neighboring light transmission portions 110 along the second direction Y by filling the plurality of slits 11 with the light blocking material formed of an organic material, an inorganic material, or a metal. After being filled in the slits 11, the light blocking material may be cured using a curing means such as ultraviolet (UV) rays such that the light blocking portions 120 can be formed. The light blocking portions 120 may be black-colored to block light.

Next, as shown in (c) of FIG. 1, the transparent base substrate 10 is cut along the major surface to separate the light transmission portions 110 and the light blocking portions 120 from the transparent base substrate 10.

In further detail, a light blocking sheet including the light transmission portions 110 and the light blocking portions 120 are manufactured by separating the light transmission portions 110 and the light blocking portions 120 from the transparent base substrate 10 using a cutting means such as a blade and the like.

Through such a process, a light blocking sheet according to a second exemplary embodiment is manufactured.

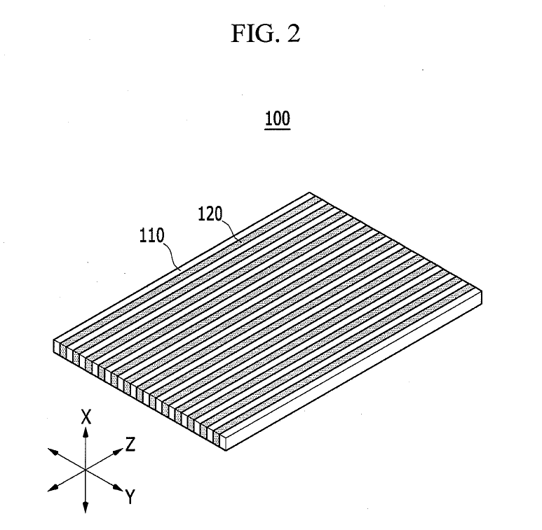

Hereinafter, a light blocking sheet according to the second exemplary embodiment will be described with reference to FIG. 2.

The light blocking sheet according to the second exemplary embodiment may be formed using the method for forming the light blocking sheet according to the first exemplary embodiment.

FIG. 2 shows a light blocking sheet according to the second exemplary embodiment.

As shown in FIG. 2, a light blocking sheet 100 according to the second exemplary embodiment is attached to a transparent display panel to suppress reflection of external light from the transparent display panel, and includes light transmission portions 110 and light blocking portions 120.

In embodiments, the light transmission portions 110 are made of a light transmissive organic material, an inorganic material, or a metal, and extend along a first direction X which is non-parallel to a major surface of the light blocking sheet 100 and are arranged at a distance from each other along a second direction Y that is substantially parallel to the major surface and crosses the first direction X. In one embodiment, the first direction may be substantially perpendicular to the major surface. In embodiments, the light transmission portions 110 extend along a third direction Z that is substantially parallel to the major surface and respectively intersects the first direction X and the second direction Y. That is, the light transmission portions 110 extend in the third direction Z while having a barrier shape and are arranged along the second direction Y. When the light transmission portions 110 are made of an organic material, the light transmission portions 110 may include at least one of polyethylene terephthalate, polycarbonate, epoxy, polyethylene, and polyacrylate. When the light transmission portions 110 are made of an inorganic material, the light transmission portions 110 may include at least one of glass, silicon oxide, silicon nitride, indium tin oxide, and indium zinc oxide.

The light block portions 120 are made of an organic material, an inorganic material, or a metal that blocks or absorbs light, and extend along the first direction X and respectively disposed between neighboring light transmission portions 110 along the second direction Y. In embodiments, each of the plurality of light blocking portions is disposed between two immediately neighboring light transmission portions. The light block portions 120 also extend in the third direction Z. That is, the light block portions 120 have barrier shapes disposed along the second direction Y while neighboring the light transmission portions 110 and extending in the third direction Z.

The light blocking sheet 100 according to the second exemplary embodiment can suppress reflection of external light caused by a transparent display panel that displays an image. This will be described in further detail later in a description of a transparent display device according to a third exemplary embodiment.

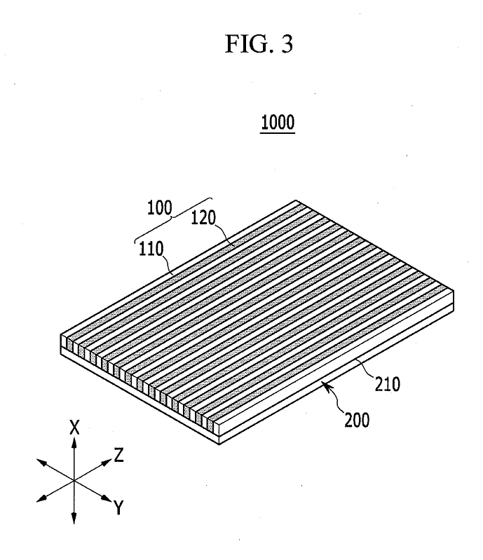

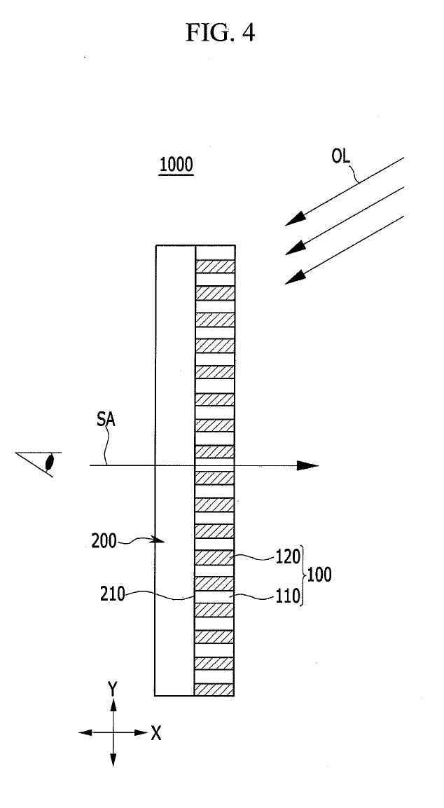

Hereinafter, a transparent display device according to the third exemplary embodiment will be described with reference to FIG. 3 and FIG. 4.

The transparent display device according to the third exemplary embodiment includes the light blocking sheet of the second exemplary embodiment.

FIG. 3 illustrates a transparent display device according to the third exemplary embodiment.

As shown in FIG. 3, a transparent display device 1000 according to the third exemplary embodiment includes a transparent display panel 200 and a light blocking sheet 100.

The transparent display panel 200 displays an image processed in the transparent display device 1000. For example, when the display device is a mobile terminal such as a mobile phone, the transparent display panel 200 may display an image such as a user interface (UI) or a graphic user interface (GUI). The transparent display panel 200 may include flexible substrates or films disposed opposite to each other, interposing a liquid crystal or an organic light emitting diode therebetween, and accordingly, the transparent display panel 200 is flexible. In addition, the transparent display panel 200 includes a light transmission area for visibility of the outside through the transparent display panel 200, and accordingly the transparent display panel 200 may be formed as a transparent type or a light transmission type.

A touch sensor formed as a touch film, a touch sheet, or a touch pad may be located in a front side of the transparent display panel 200 to sense a touch operation.

The light blocking sheet 100 is attached to a bottom surface 210 of the transparent display panel 200, and includes a plurality of light transmission portions 110 and a plurality of light blocking portions 120. The bottom surface 210 of the transparent display panel 200 extends substantially parallel with the second direction Y. In embodiments, the plurality of light transmission portions 110 extend in the first direction X that crosses the second direction Y, which is the extension direction of the bottom surface 210 of the transparent display panel 200, and are respectively disposed at a distance from each other along the second direction Y. In addition, the plurality of light blocking portions 120 extend in the first direction X that crosses the second direction Y, which is the extension direction of the bottom surface 210 of the transparent display panel 200, and are respectively disposed between neighboring light transmission portions 110 arranged along the second direction Y.

FIG. 4 is provided for description of an effect of the transparent display device according to the third exemplary embodiment.

As shown in FIG. 4, a crossing angle of the first direction X and the second direction Y is a right angle, and thus the plurality of light blocking portions 120 and the plurality of light transmission portions 110 can respectively extend along the X direction that is perpendicular to the bottom surface 210 of the transparent display panel 200.

The transparent display device 1000 includes the transparent display panel 200 and the light blocking sheet 100 that is attached to the bottom surface 210 of the transparent display panel 200 and includes the light blocking portions 120 and the light transmission portions 110 extending in the first direction X that is perpendicular to the second direction Y along which the bottom surface 210 extends, and thus when a viewing angle SA of a user is set to the first direction X that is perpendicular to the bottom surface 210 of the transparent display panel 200 and external light OL is made incident in directions other than the first direction X with respect to the transparent display panel 200, the external light OL is blocked or absorbed by the light blocking portions 120 so that reflection of the external light OL generated from the transparent display panel 200 can be suppressed.

In addition, when the viewing angle SA of the user is set to the first direction X that is perpendicular to the bottom surface 210 of the transparent display panel 200, the user can view the outside of the transparent display device 1000 through the light transmission portions 110 because the light transmission portions 110 extend in the first direction X.

As described, the transparent display device 1000 according to the third exemplary embodiment includes the light blocking sheet 100 that selectively blocks external light so that reflection of external light generated from the transparent display panel 200 can be suppressed, thereby improving visibility of an image displayed in the transparent display panel 200.

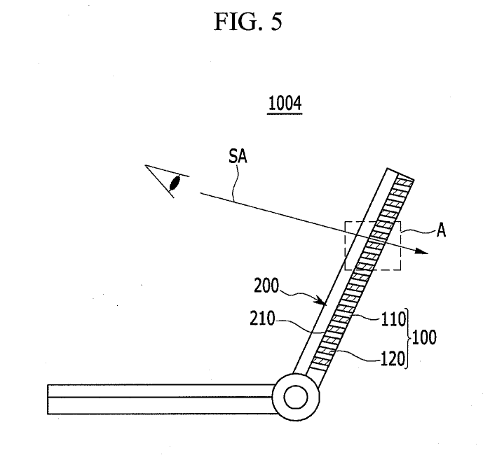

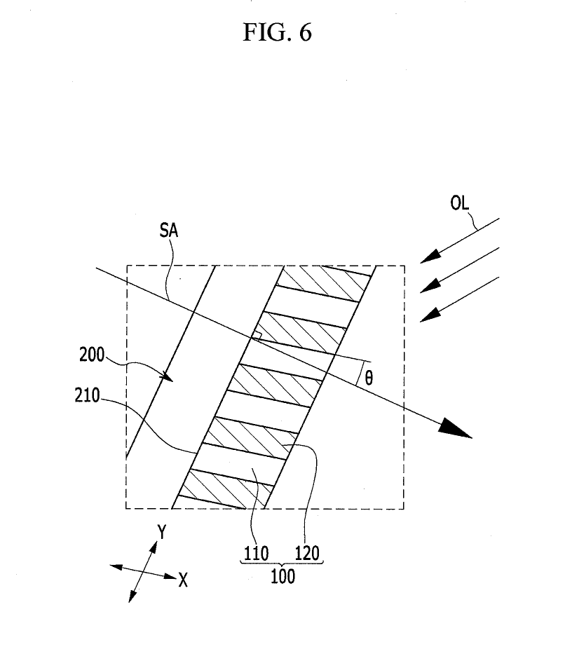

Hereinafter, a transparent display device according to a fourth exemplary embodiment will be described with reference to FIG. 5 and FIG. 6.

Hereinafter, only characteristic components distinguished from the third exemplary embodiment will be extracted and described, and the components omitted from the description follow the third exemplary embodiment. In addition, in the fourth exemplary embodiment, for convenience of description, like constituent elements will be described by using like reference numerals of the third exemplary embodiment.

FIG. 5 shows a transparent display device according to the fourth exemplary embodiment. FIG. 6 illustrates the portion “A” of FIG. 5.

As shown in FIG. 5 and FIG. 6, a crossing angle between a first direction X and a direction that is perpendicular to a second direction Y is set to a predetermined angle θ, and thus each of the plurality of light blocking portions 120 and each of the plurality of light transmission portions 110 extend in the first direction X with the angle θ set with respect to the direction that is perpendicular to the second direction Y which is the extension direction of the bottom surface 210 of the transparent display panel 200. In embodiments, the predetermined angle θ may be greater than 0°.

The transparent display device 1004 includes the transparent display panel 200 and the light blocking sheet 100 that is attached to the bottom surface 210 of the transparent display panel 200 and includes the light blocking portions 120 and the light transmission portions 110 respectively extend in the first direction X with the angle θ set with respect to the direction that is perpendicular to the second direction Y which is the extension direction of the bottom surface 210, and thus when the viewing angle SA of the user is set to a direction that is perpendicular to the bottom surface 210 of the transparent display panel 200 and external light OL is made incident to the transparent display panel 200 along a direction other than the first direction X, the external light is blocked or absorbed by the light blocking portions 120 so that reflection of the external light generated from the transparent display panel 200 can be suppressed.

In addition, when the viewing angle SA of the user is set to a direction that is perpendicular to the bottom surface 210 of the transparent display panel 200, the user can view the outside of the transparent display device 1004 through the light transmission portions 110 because the light transmission portions 110 extend in the first direction X.

As described, the transparent display device 1004 according to the fourth exemplary embodiment includes the light blocking sheet 100 that selectively blocks external light so that reflection of the external light generated from the transparent display panel 200 can be suppressed, thereby improving visibility of an image displayed in the transparent display panel 200.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

first direction X, second direction Y, light transmission portion 110, light blocking portion 120

What is claimed is:

1. A light blocking sheet comprising:
a plurality of light transmission portions extending in a first direction and arranged at a distance from each other along a second direction that crosses the first direction; and
a plurality of light blocking portions extending in the first direction, each of the plurality of light blocking portions being disposed between two immediately neighboring light transmission portions.

2. The light blocking sheet of claim 1, wherein a crossing angle of the first direction and the second direction is about 90°.

3. The light blocking sheet of claim 1, wherein the light transmission portions and the light blocking portions respectively extend in a third direction that intersects the first direction and the second direction.

4. The light blocking sheet of claim 1, wherein a crossing angle between the first direction and a direction that is perpendicular to the second direction is greater than 0°.

5. A method for manufacturing a light blocking sheet, comprising:
forming a plurality of concave slits extending in a first direction in a transparent base substrate and arranged at a distance from each other along a second direction that crosses the first direction, and a plurality of light transmission portions extending in the first direction, each of the plurality of light transmission portions being disposed between two immediately neighboring slits;
forming a plurality of light blocking portions by filling the plurality of slits with a light blocking material such that the plurality of light blocking portions extend in the first direction, and each of the plurality of light blocking portions is disposed between two immediately neighboring light transmission portions; and
cutting the transparent base substrate to separate the light transmission portions and the light blocking portions from the transparent base substrate.

6. A transparent display device comprising:
a transparent display panel displaying an image; and
the light blocking sheet of claim 1, attached to a bottom surface of the transparent display panel.

7. The transparent display device of claim 6, wherein the second direction is substantially parallel to the bottom surface of the transparent display panel.
